(19) United States
(12) Patent Application Publication
(10) Pub. No.: US 2010/0106292 A1
(43) Pub. Date: Apr. 29, 2010

(54) UNIVERSAL BILL RECYCLER

(75) Inventors: Horst Buschmann, Harsefeld (DE); Craig Lewis, Berwyn, PA (US); Anton Rakushkin, Sharon, MA (US); Victor Rogachov, Toronto (CA); Scott Hudis, Stillwater, MN (US)

Correspondence Address: DOCKET CLERK, P.O. DRAWER 800889, DALLAS, TX, 75380, US

(73) Assignee: CRANE CO., Stamford, CT (US)

(21) Appl. No.: 12/579,266

(22) Filed: Oct. 14, 2009

Related U.S. Application Data
(60) Provisional application No. 61/196,017, filed on Oct. 14, 2008.
(60) Provisional application No. 61/244,858, filed on Sep. 22, 2009.

(51) Int. Cl. G06F 17/00

(52) U.S. Cl. 700/232

(57) ABSTRACT

A vending machine includes a coin handler, a bill handler, and a vending machine controller (VMC). The bill handler communicates with the coin handler and the VMC. The bill handler includes a bill recycler and a controller. The controller receives a Coin Tubes message from the coin handler. The Coin Tubes message includes information about a coin denomination available for dispensing in the coin handler. The controller produces a second Coin Tubes message by adding information about a bill denomination available for dispensing in the bill handler to the first Coin Tubes message. The controller sends the second Coin Tubes message to the VMC. The controller receives a Change Issue message from the VMC, that identifies an amount of money to be dispensed from the vending machine. In response, the controller causes the bill recycler to dispense at least one bill.

### CROSS-REFERENCE TO RELATED APPLICATIONS AND CLAIM OF PRIORITY

The present application is related to U.S. Provisional Patent Application No. 61/196,017, filed Oct. 14, 2008, entitled “VENDING MACHINE INTEROPERABLE RECYCLER”. Provisional Patent Application No. 61/196,017 is assigned to the assignee of the present application and is hereby incorporated by reference into the present application as if fully set forth herein. The present application hereby claims priority under 35 U.S.C. §119(e) to U.S. Provisional Patent Application No. 61/196,017.

The present application also is also related to U.S. Provisional Patent Application No. 61/244,858, filed Sep. 22, 2009, entitled “UNIVERSAL BILL RECYCLER”. Provisional Patent Application No. 61/244,858 is assigned to the assignee of the present application and also is hereby incorporated by reference into the present application as if fully set forth herein. The present application also hereby claims priority under 35 U.S.C. §119(e) to U.S. Provisional Patent Application No. 61/244,858.

### TECHNICAL FIELD

The present application relates generally to vending machines and, more specifically, to a vending machine currency handling system.

### BACKGROUND

A vending machine is a machine that provides various snacks, beverages and other products to consumers by vending products without a cashier. Items sold via vending machines can vary by country and region. Vending machines typically utilize a push button interface that is capable of accepting money in paper or coin form. A consumer may insert coins into a coin acceptor or dollar bills into a bill validator, or a combination of the two. Thereafter, the consumer typically makes a product selection by entering a product identifying code into a keypad on the face of the vending machine. If the amount of money recognized by the machine equals or exceeds the amount of money required to purchase the selected product, the machine proceeds to vend the product to the consumer. However, if the consumer has inserted more money than is required to make the purchase, the machine will return the excess money (hereinafter “change”) as well as vending the product to the consumer. Thus, a vending machine is typically an unattended point of sale.

### SUMMARY

In one embodiment, a method includes receiving, in a bill handler of a vending machine, a first Coin Tubes message from a coin handler of the vending machine. The first Coin Tubes message includes information associated with a denomination of a coin type that is available for dispensing in the coin handler. The method also includes producing a second Coin Tubes message by adding information associated with a denomination of a bill type available for dispensing in the bill handler to the first Coin Tubes message.

The method further includes sending the second Coin Tubes message from the bill handler. The method still further includes receiving a first Change Issue message in the bill handler. The Change Issue message includes information identifying a first amount of money to be dispensed from the vending machine. The method also includes the bill handler dispensing at least one bill in response to the Change Issue message.

In another embodiment, a bill handler for use in a vending machine includes a bill recycler and a controller. The controller receives a first Coin Tubes message from a coin handler of the vending machine. The first Coin Tubes message includes information associated with a denomination of a coin type available for dispensing in the coin handler. The controller also produces a second Coin Tubes message by adding information associated with a denomination of a bill type available for dispensing in the bill handler to the first Coin Tubes message. The controller further sends the second Coin Tubes message from the bill handler. The controller still further receives a Change Issue message, the Change Issue message including information identifying an amount of money to be dispensed from the vending machine. The controller also causes the bill recycler to dispense at least one bill in response to the Change Issue message.

In still another embodiment, a vending machine includes a coin handler, a bill handler, and a vending machine controller (VMC). The bill handler is communicatively coupled to the coin handler and the VMC is communicatively coupled to the bill handler.

The bill handler includes a bill recycler and a controller. The bill handler controller receives a first Coin Tubes message from the coin handler. The first Coin Tubes message includes information associated with a denomination of a coin type available for dispensing in the coin handler. The controller also produces a second Coin Tubes message by adding information associated with a denomination of a bill type available for dispensing in the bill handler to the first Coin Tubes message. The controller further sends the second Coin Tubes message to the VMC. The controller still further receives a Change Issue message from the VMC, the Change Issue message including information identifying an amount of money to be dispensed from the vending machine. The controller also causes the bill recycler to dispense at least one bill in response to the Change Issue message.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram of a vending machine;

FIG. 2 illustrates a vending machine according to one embodiment of the disclosure;

FIG. 3A depicts a vending machine user interface according to one embodiment of the disclosure;

FIG. 3B depicts vending machine coin receiving and return mechanism according to one embodiment of the disclosure;

FIG. 4 is a block diagram of a vending machine controller according to one embodiment of the disclosure;

FIG. 5 is a block diagram of vending machine subsystems according to one embodiment of the disclosure;

FIG. 6 is a block diagram of a vending machine according to another embodiment of the disclosure; and

FIG. 7 is a block diagram of a bill recycler according to the disclosure.

### DETAILED DESCRIPTION

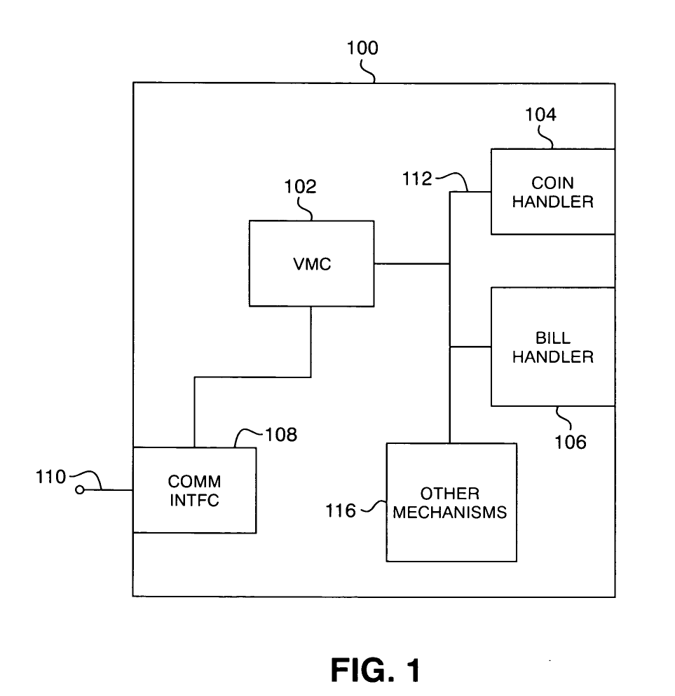

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged vending machine currency handling system.

Vending is a business that has entry level hourly employees handling cash without direct supervision. This may provide a temptation for theft. The vending industry traditionally has relied upon matching product sales with receipts to detect theft, but this practice has at least two weaknesses. First, the exact receipts are uncertain because coin mechanisms recycle some received coins to dispense as change in future transactions. Second is theft of machine use, perpetrated by an employee purchasing products at a low wholesale price and replenishing the machine with those goods, while removing a portion of the cash that represents an equivalent number of vends at the higher retail price.

One solution to these problems is provided by modern vending management software packages (Vending Management Systems or VMS packages) using DEX audit data (DEX is an acronym for Data Exchange standard, which is a subset of the Uniform Communication Standard (UCS), which is a subset of the American National Standards Institute (ANSI) Accredited Standards Committee (ASC) X12 national standard). The DEX audit data is formatted data that is output by the vending machine to a hand-held computer or sent via telemetry to a vending machine operator's computer. The DEX audit data may indicate sales, inventory, and a status of the machine. Included may be fields that report the total value of money sent to the coin and bill boxes. Any cash diversion by the route driver may then display as a variance. As such, processes have been developed to monitor sales from a vending machine. Such processes may provide accurate accounting of cash that should be returned and the products that are placed into the vending machines.

The DEX standard provides fields for reporting bills and coupons stacked in a bill collection holding area (which may be referred to as “the bill box”) and for reporting coins and tokens sent to a coin collection holding area (which may be referred to as “the coin box”). Typically, the bill box and the coin box are separate mechanisms within a vending machine.

For many years, vending machines dispensed change in coins. However, as product prices increased, accepting large denomination bills has become important.

When accepting bills of denominations that are larger than the smallest bill denomination, dispensing coins as change is problematic. For example, $5 bills, $10 bills and $20 bills may be accepted for products typically priced from $0.50 to $3. In some vending machines, still higher prices may be charged for specialty products such as plated food, cameras, and audio devices. In such circumstances, consumers may prefer to receive bills as change, rather than a “handful” of coins. Thus, receiving change in coins from inserting a $10 or $20 may be a deterrent to consumers who are considering making a purchase from such a vending machine.

Additionally, where coins are dispensed as change for products purchased using higher denomination bills, large numbers of coins may be dispensed as change, depleting the number of coins available as change in a particular vending machine. As a result, vending machine operators may be required to replenish the supply of coins in such machines more frequently, which may require significant labor and data tracking.

One solution to this problem is the use of recycling bill validators. Such devices are capable of accepting bills with a range of values and later using some or all of the bills received as change for a future transaction. Recycling bill validators may also enable a vending machine return money to a consumer in the event of the consumer cancelling a transaction.

FIG. 1 illustrates a vending machine 100 that includes a coin handler 104 and a bill handler 106. The coin handler 104 receives, validates, and stores coins in a coin box for collection and a coin changer for dispensing. The coin handler 104 also dispenses coins of one or more denominations. The coin handler includes coins stored in coin tubes for dispensing as change. The bill handler 106 receives, validates, and stores bills of one or more denominations in a bill box. Both the coin handler 104 and the bill handler 106 communicate with a vending machine controller (VMC) 102 via a communication link 112. The communication link 112 may use a vending industry standard multi-drop bus (e.g., Multi-Drop Bus/Internal Communication Protocol standard, Version 3.0, [MDB} as published by the National Automatic Merchandising

Association on Mar. 26, 2003, and incorporated herein by reference) protocol or other communication protocol. The VMC 102 may also communicate with other mechanisms 116 via the communication link 112 to control vending functions of the vending machine 100. The other mechanisms 116 may include credit card or debit card systems.

Using the communication link 112:
the VMC 102 may exchange setup and configuration messages with the coin handler 104 and the bill handler 106;
the coin handler 104 may send messages to the VMC 102 indicating a number and denomination of coins received from a consumer;
the bill handler 106 may send messages to the VMC 102 indicating a number and denomination of bills received from a consumer; and
the VMC 102 may send messages to the coin handler 104 to dispense a specified number of coins of specified denomination(s) as change.
   It will be understood that this list is not exhaustive, and that other messages may be exchanged between the VMC 102 and the coin handler 104 and the bill handler 106 via the communication link 112.

Based upon such messages, the VMC typically maintains an inventory of the numbers and denominations of coins present in the coin handler 104 and numbers and denominations of bills present in the bill handler 106. This inventory may be used for auditing sales made by the vending machine 100, for determining when to schedule a service call to the location of the vending machine 100 to replenish the inventory of coins in the coin handler 104, to remove bills from the bill handler 106, or to replenish the vending machine's products. Such messages could also include reporting abnormal machine conditions requiring repair.

The VMC 102 is also communicatively coupled to a communication interface 108. The VMC uses the communication interface 108 to communicate product inventory, maintenance status, coin/bill inventory, auditing and other information to an operator via an external communication link 110. The communication link 110 may be a wired link or a wireless link. Where the communication link 110 is a wireless link, it may employ infrared or radio frequency communication (such as Bluetooth, WiFi, and cellular). The communication link 110 may be a combination of wired and wireless communication links, where the VMC 102 communicates with certain external devices via a wired link and other external devices via a wireless link.

During a setup phase in the MDB protocol, the VMC 102 receives one or more Coin Tubes messages from the coin handler 104 and one or more Coin Inventory messages. As used herein, a Coin Tubes message is any message that specifies the denominations of coin tubes in the coin handler 104, and a Coin Inventory message is any message that specifies the number of coins in each of the coin tubes in the coin handler 104. During operation, the VMC 102 may send a Poll message to the coin handler 104, which may respond with a Coin Inventory message.

During operation, the VMC 102 may receive a Coin Credit message from the coin handler 104. As used herein, a Coin Credit message is any message indicating a denomination of a coin received from a customer and whether the coin was sent to the coin box or the coin changer. In response, the VMC 102 will add the value of the received coin to the credit available to the customer for purchasing an item from the vending machine. The VMC may also receive a Bill Credit message from the bill handler 106. As used herein, a Bill Credit message is any message indicating a denomination of a bill received from the customer and stored in the bill box.

The VMC 102 may also send one or more Change Issue messages to the coin handler 104 to dispense coins from the coin tubes as change. As used herein a Change Issue message is any message that instructs a coin handler or bill handler to dispense one or more coins or bills, respectively. Such Change Issue messages may have a first format, in which the message instructs the coin handler 104 to dispense a single coin of a specified denomination. When using the first format, the VMC 102 may issue a series of messages to cause the coin handler 104 to dispense, in the aggregate, a desired value in change. In a second format of Change Issue message, a single Change Issue message specifies a desired value of coins for the coin handler 104 to dispense as change. In response, the coin handler 104 determines a combination of numbers and denominations of available coins that totals the specified value, dispenses the determined combination of coins, and sends a message to the VMC 102 specifying the numbers and denominations of coins dispensed.

Thus, the VMC 102 has information relating to numbers and denominations of coins initially present in the coin handler 104, numbers and denominations of coins received into the coin handler 104, and numbers and denominations of coins dispensed by the coin handler 104. Based upon such information, the VMC 102 can account for all coins handled by the coin handler 104 and provide such auditing information to an external device via the communication interface 108 and the communication link 110.

Also during the setup phase in the MDB protocol, the VMC 102 may receive one or more messages from the bill handler 106 specifying the numbers and denominations of bills stored in the bill handler 106. During operation, the VMC 102 may receive one or more messages from the bill handler 106 indicating numbers and denominations of bills received from consumers and stored in the bill handler 106. The MDB protocol does not define messages by which the VMC 102 may instruct the bill handler 106 to dispense a bill as change.

Thus, the VMC 102 has information relating to numbers and denominations of bills initially present in the bill handler 106, and numbers and denominations of bills received into the bill handler 106. Based upon such information, the VMC 102 can account for all bills handled by the bill handler 106 and provide such auditing information to an external device via the communication interface 108 and the communication link 110.

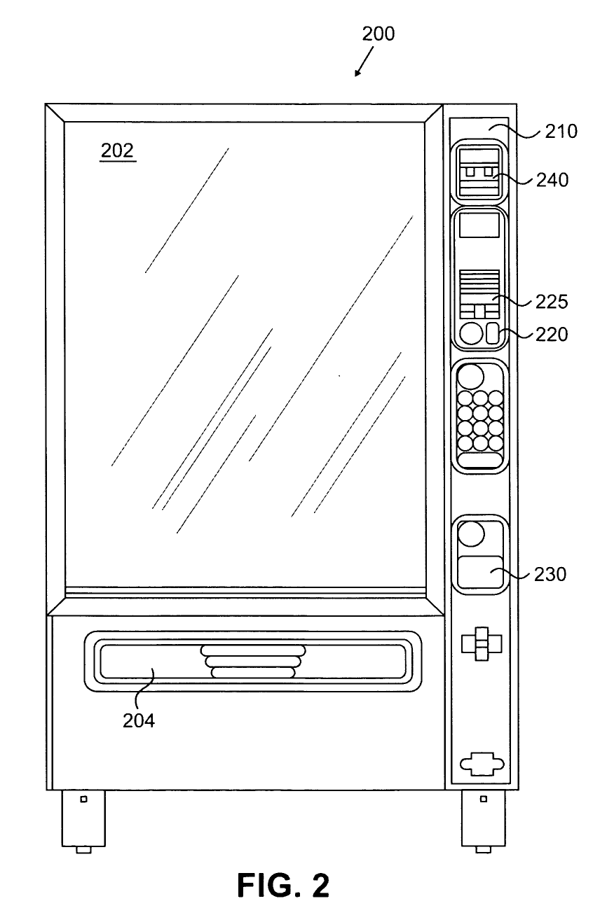

FIG. 2 illustrates a vending machine 200 according to one embodiment of the disclosure. The vending machine has a product display and storage area 202 and a delivery door 204. Additionally, the vending machine 200 has a user interface area 210. Depiction of the user interface area 210 in a continuous area along one side of the face of the vending machine is exemplary only and should not be construed as limited to this configuration. The user interface area 210 may be located along the left side of the face of the vending machine 200. Additionally or alternatively, the user interface area 210 may be located in any other user-accessible portion of the vending machine 200. While shown adjacent to each other, in other embodiments, subsections of the user interface 210 may be located in different portions of the vending machine 200.

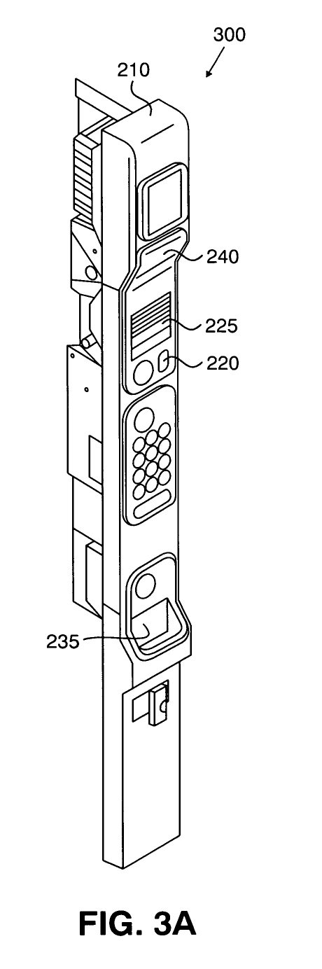

The user interface 210 includes a coin insert 220. The coin insert 220 is adapted to receive currency in the form of coins or other tokens. The user interface 210 also includes a bill validator 225. The bill validator 225 is adapted to receive currency in the form of bills, scrip, coupons, or other paper currency. The user interface 210 further includes a change return slot (or aperture) 230. The change return slot 230 is configured to return currency to a consumer in the form of coins. In some embodiments, the change return slot 230 includes a bin, or tray 235 (shown in FIG. 3A) for holding the returned coins. In some embodiments, the user interface 210 still further includes a card validator 240. The card validator 240 is configured to read data from a credit card, debit card, or other cashless transaction device, such that a vending transaction may be charged to a bank account corresponding to the cashless transaction device. In some embodiments, the card validator 240 is configured to read a card by reading data from a magnetic strip disposed on a backside of the credit card. In some embodiments, the card validator 240 is configured to extract data from a chip disposed within, or on, the cashless transaction device.

Referring now to FIGS. 3A and 3B, the user interface area (hereinafter “UI”) 210 is disposed on a front face of a control carriage 300 (also referred to as a “monetary slide”). Although only three monetary inputs (the coin insert 220, bill validator 225 and credit card validator 240) are shown, it should be understood that any suitable manner and method of payment may be incorporated without departing from the scope of the disclosure. The coin insert 220 includes logic and hardware (e.g., sensors) necessary to identify a type (e.g., denomination) and quantity of coin inserted. The bill validator 225 includes logic and hardware (e.g., sensors) necessary to identify a type (e.g., denomination) and quantity of bills inserted.

Referring now to FIG. 3B, a vending machine currency handling system 305 according to one embodiment of the disclosure is illustrated. The currency handling system 305 is disposed within the control carriage 300. The currency handling system 305 is coupled to the coin insert 220. The currency handling system 305 further is coupled to the bill validator 225. Accordingly, the currency handling system 305 is configured to receive currency from each of the coin insert 220 and the bill validator 225. The currency handling system 305 is configured to store currency in the form of coins and bills in coin handler 310 and bill handler 315, respectively.

The coin handler 310 comprises a coin receiving and dispensing mechanism 320. A coin return lever (or other actuator) of the coin receiving and dispensing mechanism 320 may be mechanically coupled to a coin return motor 325. The coin return motor 325 may be an electronically controlled actuator. The coin handler 310 includes a cash box and a plurality of change payout tubes (or coin tubes). Coins received via the coin insert 220 are sent to either the cash box or to replenish the change payout tubes. In some embodiments, the coin tubes of the coin handler 310 include one of a hopper, a tube, or a rotary device.

The bill handler 315 comprises a bill box 330 and a bill recycler 335. The bill box 330 is configured to store bills received via the bill validator 225. The bills stored in the bill box 330 are stored for collection by vending personnel. The bill recycler 335 is configured to store bills to be utilized by the controller 350 to return change to a consumer in the form of bills. The bill recycler 335 further is configured to store bill denominations separately such that a first denomination is stored separate from a second denomination (e.g., a five dollar bill is stored separately than a one dollar bill).

The currency handling system 305 is coupled to the controller 350. It will be understood that illustration of the controller 350 as positioned in a top portion of the control carriage 300 merely is exemplary. In other embodiments, the controller 350 may be disposed in any suitable location within the vending machine 200. Further, in one embodiment the controller 350 is remotely located such that the controller 350 communicates with vending machine 200 components, such as the currency handling system 305, via one of a wire-line communication or wireless communication.

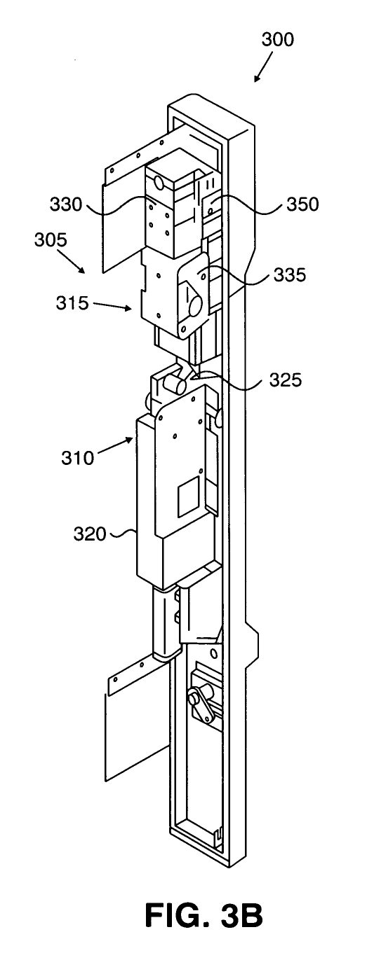

Referring now to FIG. 4, a block diagram of a vending machine controller 350 according to one embodiment of the disclosure is depicted. The controller 350 may be a computer, or any other device capable of transmitting, processing, and/or receiving signals via wireless and/or wire-line communication links. The device 350 includes a central processing unit (“CPU”) 452, a memory unit 454, an input/output (“I/O”) device 456, and a network interface 458. The network interface 458 may be, for example, one or more network interface cards (NICs) that are each associated with a media access control (MAC) address. The components 452, 454, 456, and 458 are interconnected by one or more communication links 460 (e.g., a bus). The network interface 458 enables the controller 350 to connect to a network.

It will be understood that the controller 350 may be configured differently than shown in FIG. 4 and that each of the listed components may actually represent several different components. For example, the CPU 452 may actually represent a multi-processor or a distributed processing system; the memory unit 454 may include different levels of cache memory, main memory, hard disks, and remote storage locations; and the I/O device 456 may include monitors, keyboards, and the like. Alternatively, single components may be utilized for two or more of the components illustrated.

Memory unit 454 contains programming instructions adapted to be executed by the CPU 452 to direct the currency handling system 305 through the receipt of currency and the return of change. Memory unit 454 is further adapted to store data relative to an amount of specified currency denominations to be retained in the vending machine 200 for use in change-making. For example, the data may specify that the vending machine should retain “W” dollar bills, “X” quarters, “Y” dimes and “Z” nickels. Memory unit 454 further is adapted to store one or more vending management software packages for use by the CPU 452. In some embodiments, the vending management software packages include a Vending Management Systems (“VMS”) using DEX audit data.

The DEX protocol is adapted to detect currency received as either bills or coins. In some vending machines, the DEX protocol records all bill received as sent to the bill box 330 for collection. Coins that are accepted are recorded separately, based on the coins sent to the cash box and the coins sent to replenish the change payout tubes. The DEX protocol includes fields that identify the value of coins accepted, the value of coins sent to the cash box, the value of coins sent to the tubes and the value of coins dispensed to the consumer from the tubes. Existing VMS packages are programmed to account the variations in coin destinations, but some VMS systems assume that a bill that is accepted has only one destination, the bill box 330.

Problems of accounting for the bills paid as change may arise when trying to retro-fit bill recyclers in existing vending machines. There is a large installed base of existing vending machines. As such installed machines are capital assets of their owners, the owners desire to maximize the lifetime of the machines and their period of use in commerce. With proper maintenance, a vending machine may be expected to operate for fifteen years or more.

In some vending machines with bill recyclers, cash accountability has been supported by reading the vending machine's DEX stream, altering it to reflect the redirection of bills that the machine interpreted as sent to the cash box, but were truly dispensed as change. These corrections in turn are combined in the vending machine's VMS to correct the collected figures in order to correctly reflect what may be expected in the cash box.

Other methods for reporting DEX have also been developed that require reprogramming the vending machine controller, thus providing accounting for recycled bills and eliminating the need for intercepting DEX. However, implementing such methods requires changing the way the payment systems communicate internally to the machine (for example, the coin handler and the bill validators/recyclers). The dominant protocol for such communication is MDB. New standards have been devised to implement such methods.

However, vending machines controllers and VMSs must be reprogrammed to employ such new methods and protocols. The large variety of vending machines installed and in current production make implementation of the DEX changes difficult, expensive, and time consuming to design, execute, test and deploy. Furthermore, it is unlikely that machines that have been discontinued by their manufacturer, but which are still operating successfully and have significant remaining operating life, will have their control system modified.

Reprogramming VMS software may also be difficult, expensive, and time consuming. Individual VMSs are typically complex, including specialized hand held terminals for field data collection, driver input, numerous data bases, and may produce hundreds of reports.

In contrast, the present disclosure provides DEX protocol messages that include fields to identify the value of bills accepted, the value of bills sent to the bill box 330, the value of bills sent to the bill recycler 335, and the value of bills dispensed to the consumer from the bill recycler 335. Accordingly, a VMS package in a vending machine according to embodiments of the present disclosure may account for variations in coin destinations and variations in bill destinations, without reprogramming.

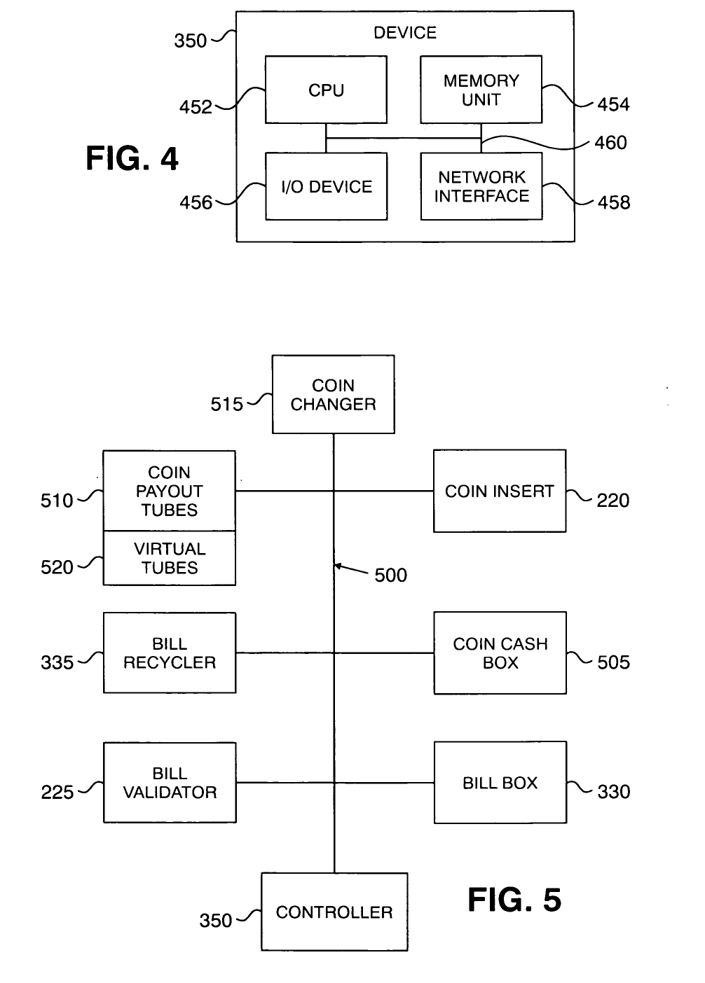

FIG. 5 is a block diagram of vending machine subsystems according to one embodiment of the present disclosure. A Multi-Drop Bus (hereinafter “MDB”) 500 is coupled to coin cash box 505, coin payout tubes (coin tubes) 510, coin insert 220, bill validator 225, bill box 330, bill recycler 335, a coin changer 515 and the controller 350. In one embodiment, the MDB 500 is an international protocol bus between the payment systems and the controller 350. The MDB protocol allows up to sixteen (16) coins and sixteen (16) tubes to be defined. The MDB 500 is configured to communicate messages between the coin payout tubes 510, coin insert 220, bill validator 225, bill box 330, bill recycler 335, coin changer 515 and the controller 350. It will be understood that illustration of the payment systems (e.g., coin payout tubes 510, coin insert 220, bill validator 225, bill box 330, bill recycler 335 and coin changer 515) as separate components merely is exemplary and one or more of the components may be combined into a single component. In some embodiments, coin payout tubes 510, coin insert 220, bill validator 225, bill box 330, bill recycler 335 and coin changer 515 are all elements of a single component. Further, it will be understood that one or more of the payments systems (e.g., coin payout tubes 510, coin insert 220, bill validator 225, bill box 330, bill recycler 335 and coin changer 515) may incorporate a controller necessary to perform the functions described herein.

The bill validator 225 intercepts the MDB 500 messages between the coin changer 515 and the controller 350 (also referred to as a vending machine controller). The coin changer 515 sends power-up messages via the MDB 500 to the controller 350. The power-up messages include a Coin Tubes message, which includes information identifying one or more coin denominations available for use as change in vending transactions. When the bill validator intercepts a Coin Tubes message, it inspects the list of coins in a Coin Tubes message to determine whether a currency value is identified for each bill denomination that the bill recycler 335 is configured to recycle. If one or more currency values are missing, the bill validator 225 alters the information of the Coin Tubes message to add fields associated with the missing currency value(s).

The currency values (e.g., bill denominations) fields that are added by the bill validator 225 represent virtual coins in virtual coin tubes. “Virtual coin tubes” are fields representing bills stored for dispensing in a bill recycler. Bills stored in the bill recycler are “virtual coins.” The virtual coins represent a value of a “coin” to the controller 350. Virtual tubes 520 are added to the coin payout tubes 510. The virtual tubes 520 enable the reporting of dispensing of a bill even if a corresponding tube does not exist in the coin changer 515.

The power-up messages also include a Coin Inventory message, which includes information representing one or more quantities of coins available for dispensing by the coin changer 515. The quantities in the Coin Inventory message correspond to the denominations identified in the Coin Tubes message. When the bill validator 225 intercepts a Coin Inventory message, it adds quantities of bills available for dispensing for any virtual coin tubes added to the Coin Tubes message.

The controller 350 periodically sends a Poll message to the coin changer 515. The Poll message requests status information from the coin changer 515. The coin changer 515 may respond with a Coin Tubes message, a Coin Inventory message, or other suitable Status message.

When the coin insert 220 accepts a coin, it reports the coin to the controller 350 using a Coin Credit message, including an indication of whether the coin was sent to the coin payout tubes 510 or to the coin cash box 505. When the bill validator 225 accepts a bill and sends the bill to the bill box 330, the bill validator 225 reports the bill to the controller 350 with a Bill Credit message.

When the bill validator 225 accepts a bill and sends the bill to the bill recycler 335, the bill validator 225 does not report the bill to the controller 350 with a Bill Credit message as a bill sent to the bill box 330. Instead, the bill validator 225 reports the bill with a Coin Credit message as a coin of the same value that was accepted and sent to the virtual tubes 520. The bill validator 225 may also intercept a Poll message from the controller 350 to the coin changer 515, and respond to the controller 350 with a Coin Inventory message indicating an updated quantity of virtual coins with the same value as the bill. This Coin Inventory message will appear to have originated from the coin changer 515, but it was produced by the bill validator 225. The message may be referred to a “pseudo changer message”.

The coin changer 515 is not aware the pseudo changer message was sent. Accordingly, if a message acknowledgment (“ACK”) is sent by the controller 350, the ACK is intercepted by the bill validator 225 and not passed to the coin changer 515. Likewise a Negative Acknowledgement (“NACK”) from the controller 350 is intercepted by the bill validator 225, which then responds to the NACK. The bill validator 225 complies with the protocol requirements and resends the pseudo changer message until an ACK is received from the controller 350.

Concurrently, the bill validator 225 monitors the time between Poll messages from the controller 350 to the coin changer 515. To prevent the coin changer 515 from “timing out” (e.g., entering an error state when too much time has elapsed between received Poll messages), the bill validator 225 passes the next Poll message on to the coin changer 515, even if the bill validator 225 has a new activity to report. The bill validator 225 thus intercepts every second Poll message sent to the coin changer 515.

In other embodiments, the bill validator 225 independently polls the coin changer 515 with a frequency that prevents the coin changer 515 from timing out. In such embodiments, the bill validator 225 stores responses from the coin changer 515 to use in responding to subsequent polls received from the controller 350.

In one example, the bill validator 225 accepts a one dollar bill ($1.00) and sends the one dollar bill to the bill recycler 335. Thereafter, the bill validator 225 reports to the controller 350 in a Coin Credit message or a Coin Inventory message that a coin valued at one dollar ($1.00) was received into an associated virtual coin tube 520. That is, the bill validator 225 sends a pseudo changer message via the MDB 500 to the controller 350. The pseudo changer message appears to come from the coin changer 515. The pseudo changer message indicates that a coin valued at one dollar ($1.00) was received and is stored in a one dollar virtual tube 520.

When a bill is dispensed as change, the bill validator 225 intercepts the next Poll message to the coin changer 515 and replies with a Coin Inventory message indicating a coin valued at one dollar ($1.00) was dispensed. The dollar bill may be dispensed from an opening in the bill validator 225 that is the same opening that the consumer inserted a bill into or the opening may be a different opening located on the user interface 210. The bill validator 225 also monitors Coin Inventory messages from the coin changer 515 that indicate the number of coins held in inventory, in the coin payout tubes 510, for dispensing. When the bill validator 225 dispenses a dollar bill from the bill recycler 335, the bill validator adjusts the amount in the one dollar virtual tube 520 accordingly. The bill validator 225 replies via the MDB 500 to the controller 350, that a coin valued at one dollar ($1.00) was dispensed.

In some embodiments, the bill recycler 335 generates the pseudo changer message. In such embodiment, when the bill validator 225 sends the bill to the bill recycler 335, the bill recycler 335 intercepts a Poll message to the coin changer 515. The bill recycler 335 responds with the pseudo changer message. Accordingly, the bill recycler 335 intercepts the ACK/NACK. If a NACK is intercepted, the bill recycler 335 responds by resending the pseudo changer message. Further, the bill recycler 335 monitors the time between Poll messages to the coin changer 515. To prevent the coin changer 515 from “timing out”, the bill recycler 335 may pass the next Poll message on to the coin changer 515, even if the bill recycler 335 has a new activity to report. The bill recycler 335 may intercept every second Poll message to the coin changer 515.

In a first operational scenario, a consumer seeks to purchase a product from the vending machine 200. At power-up, the coin changer 515 sends a power-up message to the controller 350 via the MDB 500. The power-up message includes fields that indicate that the coin changer 515 has coin payout tubes 510 for quarters ($0.25), dimes ($0.10) and nickels ($0.05). The bill validator 225 intercepts the power-up message. The bill validator 225 determines that the power-up message does not include fields for a one dollar currency value. The bill validator 225 modifies the power-up message to include fields that indicate that the coin changer 515 includes a one dollar coin and a one dollar tube holding the coin.

As the one dollar coin tube does not actually exist in this vending machine 200, the one dollar coin value is a “virtual coin” and the one dollar tube is a “virtual tube.” It will be understood that such example of the absence of a one dollar coin tube is used for exemplary purposes only and an actual one dollar coin inserted into the coin handler is sent to the cash box. However, embodiments where an actual one dollar coin is dispensed are also included within the scope of the disclosure.

A first consumer views a product in the product display and storage area 202. The first consumer identifies that the product costs one dollar ($1.35). The first consumer inserts a one dollar bill ($1.00) into the bill validator 225 and two quarters ($0.50) into the coin insert 220. The bill validator 225 identifies that one dollar has been inserted. The bill validator 225 sends the one dollar bill to the bill recycler 335. Additionally, the coin insert 220 identifies that two quarters have been inserted.

The coin changer 515 sends two Coin Credit messages to the controller 350, each indicating that a quarter has been received and stored in the coin payout tubes 510. The bill validator 225 intercepts the Coin Credit messages from the coin changer 515 and retransmits them to the controller 350.

The bill validator 225 also generates a Coin Credit message indicating that a one dollar coin was received and deposited in virtual tubes 520. The bill validator 225 sends the Coin Credit message to the controller 350 via the MDB 500. The controller 350 receives the Coin Credit message as if the message had been sent by the coin changer 515. The controller 350 sends an ACK to the coin changer 515 to acknowledge receipt of the pseudo change message. The bill validator 225 intercepts the ACK and sends a separate ACK to the coin changer 515 indicating successful receipt of the first message.

Thereafter, the first consumer makes the product selection.

The controller 350 determines that the first consumer is owed fifteen cents ($0.15) in change. The controller 350 sends a Change Issue message to the coin changer 515 via the MDB 500. The bill validator 225 intercepts the Change Issue message. The bill validator 225 identifies that only coins are required to dispense change to the first consumer. Thereafter, the bill validator 225 passes the Change Issue message on to the coin changer 515. In response, the coin changer 515 dispenses one dime and one nickel from the coin payout tubes 510.

In a second operational scenario, a second consumer views a product in the product display and storage area 202. The second consumer identifies that the product costs one dollar and twenty-five cents ($1.25). The second consumer inserts five dollars ($5.00) into the bill validator 225. The bill validator 225 identifies that a five dollar bill has been inserted. The bill validator 225 sends the five dollar bill to the bill box 330. The bill validator 225 sends a Bill Credit message to the controller 350 via the MDB 500, indicating that a five dollar bill was received and deposited in the bill box 330. The controller 350 sends an ACK indicating successful receipt of the bill received message.

The second consumer makes the product selection. The controller 350 determines that the second consumer is owed three dollars and seventy-five cents ($3.75) in change. The controller 350 sends a Change Issue message to the coin changer 515. The Change Issue message is intercepted by the bill validator 225. The bill validator 225 identifies that three dollars and seventy-five cents ($3.75) is to be dispensed. The bill validator 225 directs the bill recycler 335 to dispense three one dollar bills. The bill validator 225 modifies the Change Issue message to indicate that seventy-five cents ($0.75) is to be dispensed. The bill validator 225 sends the modified Change Issue message to the coin changer 515. In response, the coin changer 515 dispenses three quarters from the coin payout tubes 510.

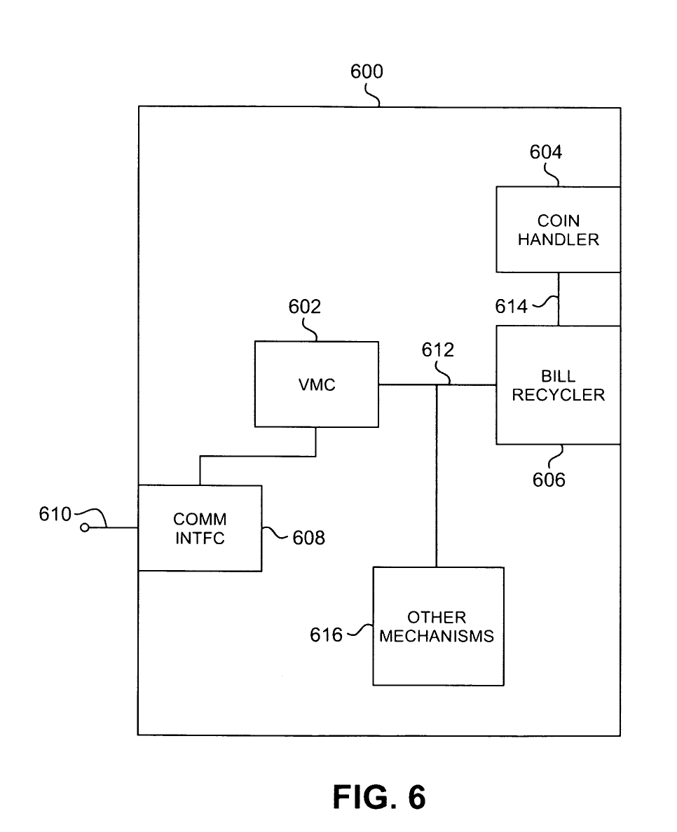

FIG. 6 is a block diagram of a vending machine 600 according to another embodiment of the disclosure. The vending machine 600 includes a coin handler 604 and a bill recycler 606. A vending machine controller (VMC) 602 communicates with the bill recycler 606 via a communication link 612. The communication link 612 may employ the MDB protocol or other suitable protocol. The VMC 602 also communicates with other mechanisms 616 via the communication link 612, in order to control vending and other functions of the vending machine 600. The VMC is further communicatively coupled to a communication interface 608 and communicates through the communication interface 608 to external devices via an external communication link 610.

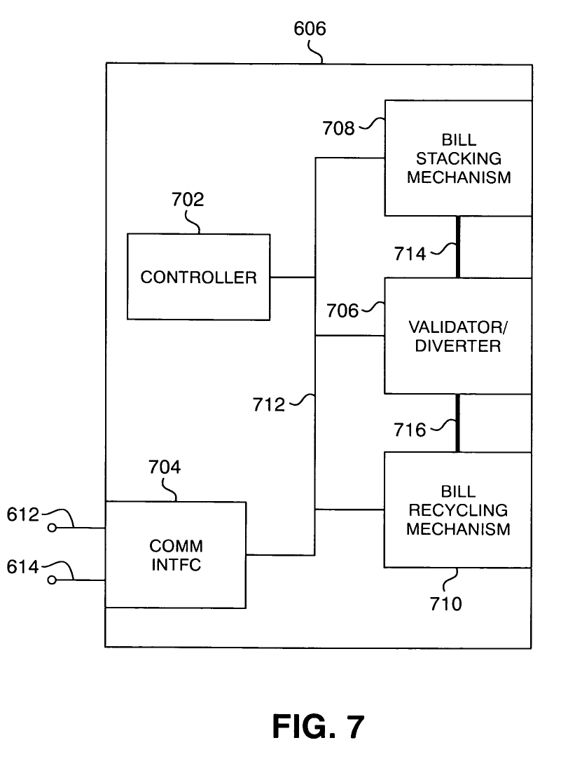

The coin handler 604 receives, validates, stores, and dispenses coins of one or more denominations. The bill recycler 606 receives, validates, stores and dispenses bills of one or more denominations. As is described in more detail with reference to FIG. 7, the bill recycler 606 includes a bill stacking mechanism that stores bills without the functionality of dispensing stored bills within it. The bill recycler 606 also includes a bill recycling mechanism that stores bills of one or more denominations and is operable to dispense bills of a specified number and denomination as change.

The bill recycler 606 communicates with the coin handler 604 via a communication link 614. The communication link 614 preferably employs the same communication protocol employed in the communication link 612. In this way, where the vending machine 600 is a previously installed machine, the bill recycler 606 may be added to the vending machine 600 without the requirement that hardware or firmware/software changes be made to the VMC 602, the communications interface 608 or the coin handler 604.

Without changes to the firmware/software, the VMC 602 is operable to exchange messages with a coin handler and a bill validator/stacker, such as the coin handler 104 and the bill handler 106 of FIG. 1. The bill recycler 606 receives messages sent by the VMC 602 to a coin handler and a bill validator/stacker. The bill recycler 606 also sends messages to the VMC 602, to provide responses that the VMC 602 expects from the coin handler and the bill validator/stacker. Certain messages and responses are handled entirely within the bill recycler 606. Other messages and responses are handled by the coin handler 604, where the bill recycler 606 operates as either a conduit or a store-and-forward device for such messages and responses.

FIG. 7 is a block diagram of a bill recycler 606 according to the disclosure. The bill recycler includes a validator/diverter 706 that receives bills inserted by a consumer.

The validator/diverter 706 performs one or more tests on the bill to determine the validity and denomination of the bill. If the bill is determined not to be valid, then the validator/diverter 706 returns the bill to the consumer. If the bill is determined to be a valid bill, the validator/diverter 706 communicates the denomination of the bill to a controller 702 via a communication link 712. In response, the controller 702 instructs the validator/diverter 706 to divert the bill to either a bill stacking mechanism (or bill box) 708 or a bill recycling mechanism 710. The validator/diverter 706 is mechanically coupled to the bill stacking mechanism 708 via a chute or aligned openings 714 and to the bill recycling mechanism 710 via a chute or aligned openings 716. The chute 714 and the chute 716 respectively operate to physically convey bills from the validator/diverter 706 to the bill stacking mechanism 708 and the bill recycling mechanism 710.

The bill stacking mechanism 708 is communicatively coupled to the controller 702 by the communication link 712 This communication over the link 712 could be between separate micro processors, but it typically comprises the controller actively operating motors/actuators of the bill stacking mechanism 708 while observing sensors that track the operation of the bill stacking mechanism 708. The bill stacking mechanism 708 may be operable to send a message to the controller 702 to indicate that a bill has been received from the validator/diverter 706.

The bill recycling mechanism 710 is also communicatively coupled to the controller 702 by the communication link 712. This communication over the link 712 could also be between separate microprocessors, but it too typically comprises the controller 702 actively operating motors/actuators of the bill recycling mechanism 710 while observing sensors that track the operation of the bill recycling mechanism 710. The bill recycling mechanism 710 may be operable to send a message to the controller 702 to indicate that a bill has been received from the validator/diverter 706.

The bill recycling mechanism 710 is also operable to receive a message from the controller 702 instructing the bill recycling mechanism 710 to dispense a bill and, where the bill recycling mechanism 710 holds bills of several denominations, indicating a denomination of the bill to be dispensed. In some embodiments, the bill recycling mechanism 710 conveys the bill to the validator/diverter 706 via the chute 716, whereupon the validator/diverter 706 dispenses the bill. In other embodiments, the bill recycling mechanism 710 has a separate outlet by which it directly dispenses the bill.

The controller 702 is communicatively coupled via the communication link 712 to a communication interface 704. The communication interface 704 is, in turn, communicatively coupled to the communication link 612 of FIG. 6 and the communication link 614 of FIG. 6. In this way, the controller 702 is able to communicate with the controller 602 of FIG. 6 via the communication link 612 and with the coin handler 604 of FIG. 6 via the communication link 614.

During a configuration phase, the controller 702 receives one or more messages from the coin handler 604 via the communication link 614, where the messages identify numbers and denominations of coins present in coin tubes of the coin handler 604. The format of the MDB configuration messages received from the coin handler 604 identifies coin tubes that are present in the coin handler, a denomination of each coin tube, and a number of coins in each coin tube. The controller 702 augments these configuration messages by including information representing one or more “virtual coin tubes,” each associated with a denomination of bills available in the bill recycling mechanism 710. When the VMC 602 sends a message requesting configuration information from the coin handler 604 via the communication link 612, the controller 702 responds with an augmented message. In this way, without changes to the firmware/software of the VMC 602, the bill recycler 606 is operable to report both coins available for dispensing from the coin handler 604 and bills available for dispensing from the bill recycler 606.

The bill recycler 606 reports bills stored in the bill stacking mechanism 708 using MDB messages developed for communicating with bill handlers such as the bill handler 106 of FIG. 1. In this way, the VMC 602 is able to account for and report currency in all three repositories of the vending machine 600: the coin handler 604, the bill stacking mechanism 708, and the bill recycling mechanism 710.

When required to dispense change from a transaction, the VMC 602 sends a message to the coin handler 604 instructing it to dispense change. Because the configuration messages sent to the VMC 602 by the bill recycler 606 included both actual coin tubes in the coin handler 604 and virtual coin tubes in the bill recycling mechanism 710, such change dispensing messages may instruct dispensing from either actual coin tubes or virtual coin tubes.

Where the controller 702 receives a change dispensing message in the format that instructs dispensation of a single coin of a specified denomination, the controller 702 may respond in either of two ways. In a first response, the controller 702 may determine whether the specified denomination is in an actual coin tube in the coin handler 604 and resend the message to the coin handler 604 via the communication link 614. Such a response would be suitable where the VMC 602 is operable to instruct the dispensing of money from both actual coin tubes and virtual coin tubes.

A second response, may be appropriate where the VMC 602 is operable only to instruct the dispensing of money from coin denominations—that is, only coins from the actual coin tubes of the coin changer 604. In this circumstance, the controller 702 may accumulate change dispensing messages until the total amount to be dispensed equals the value of a bill in the bill recycling mechanism 710. In response, the controller 702 may then instruct the bill recycling mechanism 710 to dispense a bill of that denomination. If change dispensing messages totaling less than the value of a bill have been accumulated and a predetermined amount of time passes without receiving a further change dispensing message, the controller 702 may send the accumulated change dispensing messages unaltered to the coin handler 604 via the communication link 614. Upon receipt of the accumulated messages, the coin handler 604 dispenses coins as instructed in the messages.

Where the controller 702 receives a change dispensing message in the format that instructs dispensation of a total value of change, the controller 702 may dispense as much of the total value as may be dispensed with bills. The controller 702 then changes the total value to be dispensed to reflect the remaining, undispensed value and sends a change dispensing message with the changed amount to the coin handler 604 to be dispensed in coins.

Regardless of the format of change dispensing message received, after responding to the message by dispensing currency, the controller 702 may report to the VMC 602 the numbers of coins (and “virtual coins”) dispensed from both actual coin tubes and virtual coin tubes.

In this way, the VMC 602 is operable to control and audit the coin handler 604 and the bill recycler 606 without changes to the hardware or firmware/software of either the coin handler 604 or the VMC 602. A coin handler reports coins sent to a coin box for collection and coins stored in coin tubes in a coin changer for dispensing as change. A bill handler according to the present disclosure reports bills sent to a bill box for collection and bills stored in virtual coin tubes for dispensing as change. A vending management system (VMS) that audits bills in a bill box, coins in a coin box, and coins in a coin changer will correctly audit a coin handler and bill handler according to the disclosure without programming changes, because bills in the bill recycler will be represented to the VMS as coins of equal value in coin tubes of the coin changer.

Although the present disclosure has been described with exemplary embodiments, various changes and modifications may be suggested to one skilled in the art. It is intended that the present disclosure encompass such changes and modifications as fall within the scope of the appended claims.

What is claimed is:

1. A method, comprising:
receiving in a bill handler of a vending machine a first Coin Tubes message from a coin handler of the vending machine, the first Coin Tubes message comprising information associated with a denomination of a coin type available for dispensing in the coin handler;
producing a second Coin Tubes message by adding information associated with a denomination of a bill type available for dispensing in the bill handler to the first Coin Tubes message;
sending the second Coin Tubes message from the bill handler;
receiving a first Change Issue message in the bill handler, the Change Issue message comprising information identifying a first amount of money to be dispensed from the vending machine; and
dispensing from the bill handler at least one bill in response to the Change Issue message.

2. The method of claim 1, further comprising:
receiving in a bill handler a first Coin Inventory message from the coin handler, the first Coin Inventory message comprising information associated with a quantity of coins of the coin type, where the coins are available for dispensing in the coin handler;
producing a second Coin Inventory message by adding information associated with a quantity of bills of the bill type to the first Coin Inventory message, where the bills are available for dispensing in the bill handler; and
sending the second Coin Inventory message from the bill handler.

3. The method of claim 1, further comprising:
receiving in the bill handler a bill of the bill type;
storing the bill in a bill recycler of the bill handler; and
sending a Coin Inventory message comprising updated information associated with the quantity of bills of the bill type available for dispensing in the bill handler.

4. The method of claim 1, further comprising:
receiving in the bill handler a bill of the bill type;
storing the bill in a bill recycler of the bill handler; and
sending a Coin Credit message comprising a denomination of the received bill and an indication that the bill was stored in a coin tube.

5. The method of claim 1, wherein:
the step of receiving a first Change Issue message further comprises receiving a plurality of Change Issue messages; and
the step of dispensing at least one bill further comprises dispensing a bill having a value equal to a total of the first amounts of money identified in the plurality of Change Issue messages.

6. The method of claim 1, further comprising:
sending a second Change Issue message from the bill handler to the coin handler, the second Change Issue message comprising information identifying a second amount of money to be dispensed from the coin handler,
wherein the second amount of money equals a difference between the first amount of money and a value of the bill dispensed from the bill handler in response to the first Change Issue message.

7. The method of claim 1, further comprising:
sending a Poll message from the bill handler to the coin handler, the Poll message requesting status information from the coin handler; and
receiving in the bill handler a first Status message from the coin handler, sent in response to the Poll message, the first Status message comprising information associated with a current status of the coin handler.

8. The method of claim 6, further comprising:
receiving in the bill handler a Poll message, the Poll message requesting status information from the coin handler; and
sending a second Status message, the second Status message comprising the information associated with the current status of the coin handler and information associated with a current status of the bill handler.

9. A bill handler for use in a vending machine, the bill handler comprising:
a bill recycler; and
a controller adapted to:
receive a first Coin Tubes message from a coin handler of the vending machine, the first Coin Tubes message comprising information associated with a denomination of a coin type available for dispensing in the coin handler;
produce a second Coin Tubes message by adding information associated with a denomination of a bill type available for dispensing in the bill handler to the first Coin Tubes message;
send the second Coin Tubes message from the bill handler;
receive a first Change Issue message, the Change Issue message comprising information identifying a first amount of money to be dispensed from the vending machine; and
cause the bill recycler to dispense at least one bill in response to the Change Issue message.

10. The bill handler of claim 9, wherein the controller is further adapted to:
receive a first Coin Inventory message from the coin handler, the first Coin Inventory message comprising information associated with a quantity of coins of the coin type, where the coins are available for dispensing in the coin handler;
produce a second Coin Inventory message by adding information associated with a quantity of bills of the bill type to the first Coin Inventory message, where the bills are available for dispensing in the bill recycler; and
sending the second Coin Inventory message from the bill handler.

11. The Bill handler of claim 9, wherein the controller is further adapted to:
upon receiving in the bill handler a bill of the bill type, store the bill in the bill recycler; and
send a Coin Inventory message comprising updated information associated with the quantity of bills of the bill type available for dispensing in the bill recycler.

12. The bill handler of claim 9, wherein the controller is further adapted to:
receive a plurality of Change Issue messages; and
dispense a bill having a value equal to a total of the first amounts of money identified in the plurality of Change Issue messages.

13. The bill handler of claim 9, wherein the controller is further adapted to:
send a second Change Issue message to the coin handler, the second Change Issue message comprising information identifying a second amount of money to be dispensed from the coin handler,
wherein the second amount of money equals a difference between the first amount of money and a value of the bill dispensed from the bill recycler in response to the first Change Issue message.

14. The bill handler of claim 9, wherein the controller is further adapted to:
send a Poll message to the coin handler, the Poll message requesting status information from the coin handler;
receive a first Status message from the coin handler, sent in response to the Poll message, the first Status message comprising information associated with a current status of the coin handler;
receive a Poll message, the Poll message requesting status information from the coin handler; and
send a second Status message, the second Status message comprising the information associated with the current status of the coin handler and information associated with a current status of the bill handler.

15. A vending machine, comprising:
a coin handler;
a bill handler communicatively coupled to the coin handler; and
a vending machine controller (VMC) communicatively coupled to the bill handler,
wherein the bill handler comprises a bill recycler and a controller, the bill handler controller adapted to:
receive a first Coin Tubes message from the coin handler, the first Coin Tubes message comprising information associated With a denomination of a coin type available for dispensing in the coin handler;
produce a second Coin Tubes message by adding information associated with a denomination of a bill type available for dispensing from the bill recycler to the first Coin Tubes message;
send the second Coin Tubes message to the VMC;
receive a first Coin Inventory message from the coin handler, the first Coin Inventory message comprising information associated with a quantity of coins of the coin type, where the coins are available for dispensing in the coin handler;
produce a second Coin Inventory message by adding information associated with a quantity of bills of the bill type to the first Coin Inventory message, where the bills are available for dispensing in the bill recycler;
send the second Coin Inventory message to the VMC receive a first Change Issue message from the VMC, the Change Issue message comprising information identifying a first amount of money to be dispensed from the vending machine; and
cause the bill recycler to dispense at least one bill in response to the Change Issue message.

16. The vending machine of claim 15, wherein the controller of the bill handler is further adapted to:
upon receiving in the bill handler a bill of the bill type, store the bill in the bill recycler; and
send a Coin Inventory message to the VMC, the Coin Inventory message comprising updated information associated with the quantity of bills of the bill type available for dispensing in the bill recycler.

17. The vending machine of claim 15, wherein the controller of the bill handler is further adapted to:
receive a plurality of Change Issue messages from the VMC; and
dispense a bill having a value equal to a total of the first amounts of money identified in the plurality of Change Issue messages.

18. The vending machine of claim 15, wherein the controller of the bill handler is further adapted to:
send a second Change Issue message to the coin handler, the second Change Issue message comprising information identifying a second amount of money to be dispensed from the coin handler,
wherein the second amount of money equals a difference between the first amount of money and a value of the bill dispensed from the bill recycler in response to the first Change Issue message.

19. The vending machine of claim 15, wherein the controller of the bill handler is further adapted to:
send a Poll message to the coin handler, the Poll message requesting status information from the coin handler;
receive a first Status message from the coin handler, sent in response to the Poll message, the first Status message comprising information associated with a current status of the coin handler.

20. The vending machine of claim 19, wherein the controller of the bill handler is further adapted to:
receive a Poll message from the VMC, the Poll message requesting status information from the coin handler; and
send a second Status message, the second Status message comprising the information associated with the current status of the coin handler and information associated with a current status of the bill handler.
